(19) United States
(12) Patent Application Publication
(10) Pub. No.: US 2026/0081210 A1
(43) Pub. Date: Mar. 19, 2026

(54) LITHIUM SECONDARY BATTERY

(71) Applicants: SK ON CO., LTD., Seoul (KR); SK INNOVATION CO., LTD., Seoul (KR)

(72) Inventors: Min Woo PARK, Daejeon (KR); Jeong Yun KIM, Daejeon (KR); Myoung Lae KIM, Daejeon (KR); Hyun Ji JEON, Daejeon (KR); In Haeng CHO, Daejeon (KR)

(21) Appl. No.: 19/326,737

(22) Filed: Sep. 12, 2025

(30) Foreign Application Priority Data
Sep. 13, 2024 (KR) 10-2024-0125636

(51) Int. Cl. H01M 10/056; C07F 9/40; H01M 4/58; H01M 4/62

(52) U.S. Cl. CPC H01M 10/056; C07F 9/4012; H01M 4/58; H01M 4/623; H01M 4/625; H01M 2300/0037

(57) ABSTRACT

A lithium secondary battery according to embodiments of the present disclosure may include a cathode including a lithium metal phosphate, an anode disposed opposite to the cathode, a lithium salt, an organic solvent, and a phosphonate-based additive represented by Formula 1. The lithium secondary battery according to exemplary embodiments of the present disclosure may exhibit reduced initial resistance and improved low-temperature capacity properties and high-temperature capacity properties.

### CROSS-REFERENCE TO RELATED APPLICATIONS

This application claims priority under 35 U.S.C. § 119 to Korean Patent Application No. 10-2024-0125636, filed on Sep. 13, 2024, the disclosure of which is incorporated herein by reference in its entirety.

### BACKGROUND OF THE INVENTION

### 1. Field of the Invention

The present disclosure relates to a lithium secondary battery, and more particularly to a lithium secondary battery that includes an electrolyte including a solvent and an electrolyte salt.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as hybrid vehicles.

Examples of secondary batteries may include a lithium secondary battery, a nickel-cadmium battery, a nickel-hydrogen battery and the like. Among them, the lithium secondary battery has a high operating voltage and a high energy density per unit weight, making it advantageous in terms of charging speed and weight reduction. In this regard, the lithium secondary battery has been actively developed and applied to various industrial fields.

For example, the lithium secondary battery may include: an electrode assembly including a cathode, an anode, and a separation membrane (separator); and an electrolyte in which the electrode assembly is impregnated. The lithium secondary battery may further include, for example, a pouch-type outer case in which the electrode assembly and the electrolyte are accommodated.

As the application range of lithium secondary batteries expands, longer cycle life, higher capacity, and improved operational stability are required. Accordingly, lithium secondary batteries that provide consistent output and capacity even during repeated charge and discharge cycles are preferred.

However, with repeated charge and discharge, for example, the output and capacity may decrease due to surface damage of the nickel-based lithium metal oxide used as a cathode active material, and side reactions between the nickel-based lithium metal oxide and the electrolyte may occur. In addition, the stability of the battery may deteriorate under harsh environments such as high or low temperatures.

### SUMMARY OF THE INVENTION

An object of the present disclosure is to provide a lithium secondary battery with reduced initial resistance and improved low- and high-temperature properties.

A lithium secondary battery according to exemplary embodiments may include: a cathode including a lithium metal phosphate; an anode disposed opposite to the cathode; and an electrolyte including a lithium salt, an organic solvent, and a phosphonate-based additive including a compound represented by Formula 1 below.

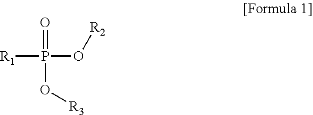

In Formula 1, R₁ may be an alkyl group having 1 to 8 carbon atoms, and R₂ and R₃ may each independently be an alkylsilyl group having 1 to 6 carbon atoms.

In some embodiments, in Formula 1, R₁ may be a methyl group or an ethyl group.

In some embodiments, in Formula 1, R₂ and R₃ may be the same.

In some embodiments, in Formula 1, at least one of R₂ and R₃ may be a trimethylsilyl group.

In some embodiments, in Formula 1, R₂ and R₃ may each independently be a trimethylsilyl group.

In some embodiments, the phosphonate-based additive may include a compound represented by Formula 1-1 below.

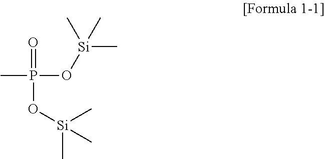

In some embodiments, the phosphonate-based additive may be included in an amount of 0.01% by weight to 10% by weight based on the total weight of the electrolyte.

In some embodiments, the electrolyte may further include at least one auxiliary additive selected from the group consisting of a cyclic carbonate compound, a fluorine-substituted cyclic carbonate compound, a sultone compound, a cyclic sulfate compound, a cyclic sulfite compound, a phosphate compound and a borate compound.

In some embodiments, the auxiliary additive may be included in an amount of 0.01% by weight to 5% by weight based on the total weight of the electrolyte.

In some embodiments, the organic solvent may include at least one selected from the group consisting of ethylene carbonate (EC), ethyl methyl carbonate (EMC), dimethyl carbonate (DMC), and diethyl carbonate (DEC).

In some embodiments, the lithium metal phosphate may include lithium iron phosphate (LiFePO₄, LFP).

The lithium secondary battery according to exemplary embodiments of the present disclosure may exhibit reduced initial resistance and improved low- and high-temperature capacity properties.

The lithium secondary battery according to exemplary embodiments may exhibit improved stability and cycle life properties.

### BRIEF DESCRIPTION OF THE DRAWINGS

The above and other objects, features and other advantages of the present disclosure will be more clearly understood from the following detailed description taken in conjunction with the accompanying drawings, in which:

FIGS. 1 and 2 are schematic plan and cross-sectional views, respectively, illustrating a lithium secondary battery according to exemplary embodiments.

### DETAILED DESCRIPTION OF THE INVENTION

According to exemplary embodiments of the present disclosure, there is provided a secondary battery that includes a cathode including a lithium metal phosphate, an anode, and an electrolyte including a phosphonate-based additive.

Hereinafter, embodiments of the present disclosure will be described in detail with reference to the accompanying drawings. However, these are merely illustrative and the present disclosure is not limited to the specific embodiments described as examples.

Unless otherwise defined herein, when a portion such as a layer, film, thin film, region, or plate, etc. is present “on” or “above” another portion, it may include not only the case where the portion is present “directly on” the other portion, but also the case where another portion is present between them.

If there is an isomer of a compound represented by a formula used herein, the compound represented by the corresponding formula refers to the representative formula including such isomers.

An electrolyte for a secondary battery according to exemplary embodiments (hereinafter, also abbreviated as “electrolyte”) may include an organic solvent, an electrolyte (e.g., a lithium salt), and a phosphonate-based additive.

The organic solvent may include an organic compound that has sufficient solubility in the lithium salt and the phosphonate-based additive, and is electrochemically stable without exhibiting reactivity in the lithium secondary battery. For example, the organic solvent may include at least one of a carbonate solvent, an ester solvent, an ether solvent, a ketone solvent, an alcohol solvent and an aprotic solvent. These may be used alone or in combination of two or more thereof.

Examples of the carbonate solvent may include propylene carbonate (PC), ethylene carbonate (EC), butylene carbonate, diethyl carbonate (DEC), dimethyl carbonate (DMC), ethyl methyl carbonate (EMC), methyl propyl carbonate, ethyl propyl carbonate, dipropyl carbonate, vinylene carbonate and the like.

Examples of the ester solvent may include methyl acetate (MA), ethyl acetate (EA), n-propyl acetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), gamma-butyrolactone (GBL), decanolide, valerolactone, mevalonolactone, caprolactone and the like.

Examples of the ether organic solvent may include dibutyl ether, tetraethylene glycol dimethyl ether (TEGDME), diethylene glycol dimethyl ether (DEGDME), dimethoxy ethane, diethoxy ethane, tetrahydrofuran (THF), 2-methyltetrahydrofuran and the like.

Examples of the ketone solvent may include cyclohexanone.

Examples of the alcohol solvent may include ethyl alcohol, isopropyl alcohol and the like.

Examples of the aprotic solvent may include dimethyl sulfoxide, acetonitrile, sulfolane, propylene sulfite and the like.

In some embodiments, the organic solvent used herein may include the carbonate solvent. For example, at least one of ethylene carbonate (EC), ethyl methyl carbonate (EMC), dimethyl carbonate (DMC), and diethyl carbonate (DEC) may be used as the organic solvent. In one embodiment, two or more of ethylene carbonate (EC), ethyl methyl carbonate (EMC), dimethyl carbonate (DMC), and diethyl carbonate (DEC) may be used in combination as the organic solvent.

The organic solvent may be used as the balance or the remainder excluding the components described below included in the electrolyte.

The lithium salt may be represented as Li⁺X⁻, for example, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)N⁻, (FSO₂)N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)N⁻ may be exemplified. These may be used alone or in combination of two or more thereof.

In one embodiment, the lithium salt may be included at a concentration of 0.01 M to 5 M, 0.01 M to 2 M, or 0.1 M to 2 M based on the organic solvent. Within this range, the transfer of lithium ions and/or electrons may be facilitated during charging and discharging of the lithium secondary battery, thereby improving capacity properties.

According to exemplary embodiments, the phosphonate-based additive may include a compound represented by Formula 1 below.

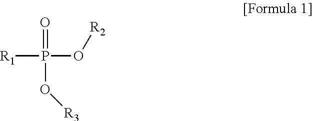

In Formula 1, R₁ may be an alkyl group having 1 to 8, 1 to 6, or 1 to 4 carbon atoms.

In Formula 1, R₂ and R₃ may each independently be an alkylsilyl group having 1 to 6, 1 to 4, or 2 to 4 carbon atoms.

The term “alkylsilyl group” as used herein may refer to a compound in which at least one of the hydrogen atoms bonded to the silyl group is substituted with an alkyl group. For example, the alkylsilyl group may refer to a compound in which at least one of the hydrogen atoms included in “—SiH₃” is substituted with an alkyl group.

The phosphonate group included in the phosphonate compound represented by Formula 1 may form a stable protective layer on an active material at high temperatures. For example, the protective layer may be formed on the active material by the phosphorus atom of the phosphonate group. Accordingly, the phosphonate compound represented by Formula 1 may stably protect the active material, thereby improving the cycle life and capacity properties at high temperature of the secondary battery. In addition, the phosphonate compound represented by Formula 1 includes an alkylsilyl group, so that a solid electrolyte interface (SEI) film or a cathode electrolyte interface (CEI) film may be stably formed on the surface of an anode or a cathode when the secondary battery is charged and discharged. Accordingly, the cycle life degradation due to expansion and contraction of the anode active material may be suppressed, and the initial resistance may be reduced.

In some embodiments, R₁ in Formula 1 may be an alkyl group having 2 or less carbon atoms. For example, R₁ in Formula 1 may be a methyl group or an ethyl group. Accordingly, the phosphorus content per unit molecule may increase, thereby facilitating formation of a protective layer and stably protecting the active material. Consequently, the cycle life properties of a secondary battery including the phosphonate compound may be improved.

In one embodiment, R₁ in Formula 1 may be a methyl group. Accordingly, the cycle life properties of the secondary battery including the phosphonate compound may be further improved.

In some embodiments, R₂ and R₃ in Formula 1 may be the same. For example, R₂ and R₃ in Formula 1 may be alkylsilyl groups having the same number of carbon atoms and an identical structure. Consequently, the initial resistance of the secondary battery including the compound represented by Formula 1 may be reduced, and low-temperature properties may be improved.

In some embodiments, at least one of R₂ and R₃ may be a trimethylsilyl group. Accordingly, the phosphorus and silicon content per unit molecule of the phosphonate compound may increase, thereby improving the low- and high-temperature capacity properties, while reducing the initial resistance.

In one embodiment, R₂ and R₃ may each independently be a trimethylsilyl group. Accordingly, the low- and high-temperature capacity properties may be further improved, and the initial resistance may be further reduced.

In some embodiments, the phosphonate-based additive may include a compound represented by Formula 1-1 below.

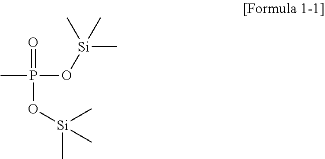

The compound represented by Formula 1-1 includes a phosphonate group, a trimethylsilyl group, and a methyl group directly bonded to the phosphorus atom. Accordingly, the internal resistance of the secondary battery including the compound represented by Formula 1-1 may be reduced, and the high- and low-temperature properties may be improved.

In some embodiments, the phosphonate-based additive may be included in an amount of 0.01% by weight (“wt %”) to 10 wt %, 0.1 wt % to 10 wt %, or 0.1 wt % to 8 wt % based on the total weight of the electrolyte. Within this range, the phosphonate-based additive may form a protective film on the cathode active material or the anode active material, thereby stabilizing the electrode. Accordingly, the output properties and cycle life properties of the secondary battery may be improved.

In one embodiment, the phosphonate-based additive may be included in an amount of 0.1 wt % to 5 wt %, 0.1 wt % to 3 wt %, or 0.1 wt % to 2 wt % based on the total weight of the electrolyte. Within this range, the output properties and cycle life properties of the secondary battery including the phosphonate-based additive may be further improved.

In some embodiments, the electrolyte may further include an auxiliary additive. The auxiliary additive may include, for example, a cyclic carbonate compound, a fluorine-substituted carbonate compound, a sultone compound, a cyclic sulfate compound, a cyclic sulfite compound, a phosphate compound and a borate compound. These may be used alone or in combination of two or more thereof.

The cyclic carbonate compound may include vinylene carbonate (VC), vinyl ethylene carbonate (VEC), etc.

The fluorine-substituted carbonate compound may include fluoroethylene carbonate (FEC), etc.

The sultone compound may include 1,3-propane sultone, 1,3-propene sultone, 1,4-butane sultone, etc.

The cyclic sulfate compound may include 1,2-ethylene sulfate, 1,2-propylene sulfate, etc.

The cyclic sulfite compound may include ethylene sulfite, butylene sulfite, etc.

The phosphate compound may include lithium difluoro bis(oxalato) phosphate, lithium difluorophosphate, etc.

The borate compound may include lithium bis(oxalate) borate, etc.

In some embodiments, the auxiliary additive may be included in an amount of 0.01 wt % to 5 wt %, 0.05 wt % to 5 wt %, 0.1 wt % to 5 wt %, 0.1 wt % to 3 wt %, or 0.1 wt % to 2 wt %. Within this content range, a protective film may be formed on the cathode active material or anode active material together with the above-described phosphonate-based additive, thereby improving the durability of the protective film. Accordingly, the cycle life properties and capacity properties of the secondary battery including the auxiliary additive may be further enhanced.

According to exemplary embodiments, the electrolyte may not include additional additives other than the above-described phosphonate-based additive and auxiliary additive. In some embodiments, the electrolyte may not include an additive including a siloxane group other than the above-described phosphonate-based additive and auxiliary additive. Accordingly, the internal resistance of the lithium secondary battery may be reduced, and the cycle life properties and capacity retention may be improved.

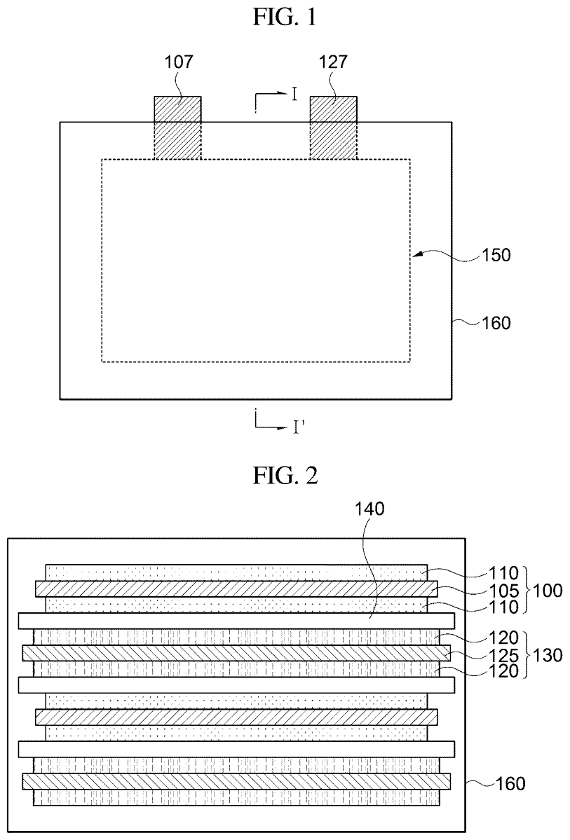

FIGS. 1 and 2 are schematic plan and cross-sectional views, respectively, illustrating a lithium secondary battery according to exemplary embodiments. For example, FIG. 2 is a cross-sectional view taken along line I-I′ of FIG. 1 in the thickness direction of the lithium secondary battery.

Referring to FIGS. 1 and 2, the lithium secondary battery may include a cathode 100, an anode 130 disposed opposite to the cathode 100, and the above-described electrolyte.

The cathode 100 may include a cathode current collector 105, and a cathode active material layer 110 disposed on at least one surface of the cathode current collector 105.

The cathode current collector 105 may include stainless steel, nickel, aluminum, titanium, or an alloy thereof. The cathode current collector 105 may also include aluminum or stainless steel having a surface treated with carbon, nickel, titanium or silver. For example, the cathode current collector 105 may have a thickness of 10 μm to 50 μm.

The cathode active material layer 110 may include a cathode active material.

According to exemplary embodiments, the cathode active material may include a lithium metal phosphate. The lithium metal phosphate may include, for example, a compound represented by Formula 2 below.

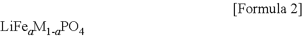

In Formula 2, a may satisfy 0<a≤1.

The chemical structure represented by Formula 2 may indicate a bonding relationship between elements included in the layered structure or crystal structure of the cathode active material.

M may be Fe. Fe may serve as the main active element of the cathode active material.

In Formula 2, M may be added to the main active element (Fe) and used as an auxiliary element to enhance the chemical stability of the cathode active material or the layered structure or crystal structure.

The auxiliary element may include, for example, at least one of Na, Mg, Ca, Y, Ti, Hf, V, Nb, Ta, Cr, Mo, W, Cu, Ag, Zn, B, Al, Ga, C, Si, Sn, Sr, Ba, Ra, P and Zr. The auxiliary element may act, for example, as an auxiliary active element that contributes to the capacity/output activity of the cathode active material together with Fe.

In some embodiments, the lithium metal phosphate may be a lithium iron phosphate (LFP) active material. For example, the lithium iron phosphate active material may be LiFePO₄. The LFP active material is structurally more stable than NCM active materials, and thus may have higher cycle life properties and stability. When a secondary battery using the LFP active material as a cathode active material includes the above-described phosphonate-based additive, the cycle life properties may be further improved, and the resistance may be further reduced.

For example, the cathode active material may not include additional compounds other than the above-described lithium metal phosphate. For example, it may not include a lithium transition metal oxide compound (e.g., an NCM compound).

If the cathode active material includes the lithium transition metal oxide compound, the stability of the cathode may be degraded. For example, when the cathode active material does not include the lithium transition metal oxide compound, the stability of the cathode may be improved, thereby improving cycle life properties.

For example, a cathode slurry may be prepared by mixing the cathode active material in a solvent. The cathode slurry may be applied to the cathode current collector, and then dried and roll-pressed to prepare the cathode active material layer 110. Specifically, the cathode slurry may be coated on the cathode current collector 105, followed by drying and roll-pressing, to prepare the cathode active material layer 110. The coating process may be performed using methods such as gravure coating, slot die coating, simultaneous multilayer die coating, imprinting, doctor blade coating, dip coating, bar coating or casting, etc., but is not limited thereto. The cathode active material layer 110 may further include a binder, and optionally may further include, a conductive material, a thickener or the like.

Non-limiting examples of the solvent used in the preparation of the cathode active material layer 110 may include N-methyl-2-pyrrolidone (NMP), dimethylformamide, dimethylacetamide, N,N-dimethylaminopropylamine, ethylene oxide, tetrahydrofuran and the like.

The binder may include polyvinylidene fluoride (PVDF), poly(vinylidene fluoride-co-hexafluoropropylene), polyacrylonitrile, polymethyl methacrylate, acrylonitrile butadiene rubber (NBR), poly(butadiene) rubber (BR), styrene-butadiene rubber (SBR) and the like. In one embodiment, a PVDF-based binder may be used as the cathode binder.

The conductive material may be added to the cathode active material layer 110 to enhance the conductivity thereof and/or the mobility of lithium ions or electrons. For example, the conductive material may include carbon-based conductive materials such as graphite, carbon black, acetylene black, Ketjen black, graphene, carbon nanotubes, vapor-grown carbon fibers (VGCFs), and carbon fibers, and/or metal-based conductive materials, including perovskite materials, such as tin, tin oxide, titanium oxide, LaSrCoO₃, and LaSrMnO₃, but is not limited thereto.

The cathode active material layer 110 may further include a thickener and/or a dispersant. For example, the cathode active material layer 110 may include a thickener such as carboxy methyl cellulose (CMC).

The anode 130 may include an anode current collector 125, and an anode active material layer 120 formed on at least one surface of the anode current collector 125.

Non-limiting examples of the anode current collector 125 may include a copper foil, a nickel foil, a stainless steel foil, a titanium foil, a nickel foam, a copper foam, a polymer substrate coated with a conductive metal and the like. The anode current collector 125 may have, for example, a thickness of 10 μm to 50 μm, but is not limited thereto.

The anode active material layer 120 may include an anode active material. As the anode active material, a material capable of adsorbing and desorbing lithium ions may be used. For example, as the anode active material, carbon-based materials such as crystalline carbon, amorphous carbon, carbon composites, or carbon fibers, etc.; lithium metal; a lithium alloy; a silicon (Si)-containing material or a tin (Sn)-containing material may be used.

For example, the amorphous carbon may include hard carbon, soft carbon, coke, mesocarbon microbead (MCMB), mesophase pitch-based carbon fiber (MPCF) or the like.

For example, the crystalline carbon may include graphitic carbon such as natural graphite, artificial graphite, graphitized coke, graphitized MCMB, graphitized MPCF or the like.

The lithium metal may include pure lithium metal or lithium metal having a protective layer formed thereon for suppressing dendrite growth or the like. In one embodiment, a lithium metal-containing layer deposited or coated on the anode current collector 125 may also be used as the anode active material layer 120. In one embodiment, a lithium thin film layer may also be used as the anode active material layer 120.

Elements contained in the lithium alloy may include aluminum, zinc, bismuth, cadmium, antimony, silicon, lead, tin, gallium, indium, etc.

The silicon-containing material may provide further increased capacity properties. The silicon-containing material may include Si, SiOx (0<x<2), a metal-doped SiOx (0<x<2), a silicon-carbon composite, etc. The metal may include lithium and/or magnesium, and the metal-doped SiOx (0<x<2) may include a metal silicate.

For example, the anode active material may be mixed in a solvent to prepare an anode slurry. The anode slurry may be coated or deposited on the anode current collector 125, and then dried and roll-pressed to prepare the anode active material layer 120. The coating may include processes such as gravure coating, slot die coating, simultaneous multilayer die coating, imprinting, doctor blade coating, dip coating, bar coating or casting, etc. The anode active material layer 120 may further include a binder, and optionally may further include a conductive material, a thickener or the like.

In some embodiments, the anode 130 may include the anode active material layer 120 in the form of lithium metal formed through a deposition/coating process.

Non-limiting examples of solvents for the anode active material layer 120 may include water, pure water, deionized water, distilled water, ethanol, isopropanol, methanol, acetone, n-propanol, t-butanol and the like.

The above-described materials that can be used when preparing the cathode as the binder, conductive material and thickener may also be used for the anode.

In some embodiments, a styrene-butadiene rubber (SBR)-based binder, carboxymethyl cellulose (CMC), polyacrylic acid-based binder, poly(3,4 ethylenedioxythiophene) (PEDOT)-based binder, and the like may be used as an anode binder.

A separation membrane 140 may be interposed between the cathode 100 and the anode 130. The separation membrane 140 may be configured to prevent an electrical short-circuit between the cathode and the anode, and to allow the flow of ions. For example, the separation membrane 140 may have a thickness of 10 μm to 20 μm, but the present disclosure is not limited thereto.

For example, the separation membrane 140 may include a porous polymer film or a porous nonwoven fabric. The porous polymer film may include a polyolefin-based polymer such as an ethylene polymer, a propylene polymer, an ethylene/butene copolymer, an ethylene/hexene copolymer, and an ethylene/methacrylate copolymer, etc. The porous nonwoven fabric may include glass fibers having a high melting point, polyethylene terephthalate fibers, etc. The separation membrane 140 may also include a ceramic-based material. For example, inorganic particles may be coated on the polymer film or dispersed within the polymer film to improve heat resistance.

The separation membrane 140 may have a single-layer or multi-layer structure including the above-described polymer film and/or non-woven fabric.

According to exemplary embodiments, the cathode 100, the anode 130, and the separation membrane 140 may be repeatedly disposed to form an electrode assembly 150. In some embodiments, the electrode assembly 150 may be a winding-type, a stacking-type, a z-folding-type, or a stacked-folding type.

The electrode assembly 150 may be accommodated in the case 160 together with the above-described electrolyte according to the exemplary embodiments to define the lithium secondary battery.

For example, electrode tabs (cathode tabs and anode tabs) may protrude from the cathode current collector 105 and the anode current collector 125, respectively, and may extend to one side of the case 160. The electrode tabs may be fused together with the one side of the case 160 to form electrode leads (a cathode lead 107 and an anode lead 127) that extend or are exposed to the outside of the case 160.

For example, a pouch-type case, a prismatic case, a cylindrical case, or a coin-type case may be used as the case 160.

Hereinafter, the embodiments of the present disclosure will be further described with reference to specific experimental examples. The examples and comparative examples included in the experimental examples are merely illustrative of the present disclosure and do not limit the scope of the appended claims. It will be apparent to those skilled in the art that various changes and modifications to the examples can be made within the scope and technical spirit of the present disclosure, and it is also understood that such changes and modifications fall within the scope of the appended claims.

### Synthesis of Phosphonate-Based Additive

### (1) Synthesis Example 1 (Synthesis of Compound Represented by Formula 1-1)

1.4 g (11.3 mmol) of dimethyl methylphosphonate and 20 ml of anhydrous acetonitrile were added to a round-bottom flask and stirred.

Then, 4.5 ml (33.8 mmol) of bromotrimethylsilane was slowly added to the reaction solution and stirred at 50° C. for 2 hours.

After completion of the reaction, the reaction product was concentrated under reduced pressure to remove the solvent and purified by distillation to obtain 2.4 g of the compound represented by Formula 1-1 (yield: 89%, ¹H-NMR (500 MHz, CDCl₃): 1.47 (3H, d), 0.33 (18H, s)).

### EXAMPLES AND COMPARATIVE EXAMPLES

### Example 1

### (1) Preparation of Electrolyte

A 1.2 M LiPF₆ solution (a mixed solvent of EC/EMC at a volume ratio of 25:75) was prepared. Based on the total weight of the electrolyte, 0.5 wt % of fluoroethylene carbonate (FEC) and 1.0 wt % of vinylene carbonate (VC) were added to the LiPF₆ solution, and 0.5 wt % of the compound represented by Formula 1-1 was added as a phosphonate-based additive.

### (2) Manufacture of Lithium Secondary Battery

LiFePO₄ as a cathode active material, carbon black as a conductive material, and polyvinylidene fluoride (PVDF) as a binder were mixed at a weight ratio of 98:1:1 to prepare a slurry. The slurry was uniformly applied to an aluminum foil having a thickness of 12 μm, and then dried and roll-pressed to fabricate a cathode for a lithium secondary battery.

An anode slurry, which included 95 wt % of an anode active material obtained by mixing artificial graphite and natural graphite at a weight ratio of 7:3, 3 wt % of Super-P as a conductive material, 1 wt % of styrene-butadiene rubber (SBR) as a binder, and 1 wt % of carboxymethyl cellulose (CMC) as a thickener, was prepared.

The anode slurry was uniformly applied to a copper foil (thickness: 6 μm) having a protrusion portion (an anode tab) on one side, excluding the protrusion portion, and then dried and roll-pressed to fabricate an anode.

The cathode and anode fabricated as described above were each cut to a predetermined size and stacked. A separator (polyethylene, thickness: 12 μm) was interposed between the cathodes and anodes to form an electrode assembly. The tab portions of the cathode and anode were then welded.

The electrode assembly was placed in a pouch, followed by sealing three sides of the pouch except for one side for electrolyte injection. At this time, a portion having the electrode tab was included in the sealed part. After injecting the electrolyte prepared in (1) above through the electrolyte injection side, the remaining electrolyte injection side was also sealed, followed by allowing it to be impregnated for 12 hours or more to manufacture a lithium secondary battery.

### Examples 2 to 4 and Comparative Examples 1 to 8

Secondary batteries were manufactured in the same manner as in Example 1, except that the mixing ratio of the lithium source and the transition metal precursor, the calcination temperature, the calcination time, and the doping element content were adjusted as shown in Table 1 below.

TABLE 1

| | Electrolyte | | | |
|---|---|---|---|---|
| | Type of | | Type and ratio of cathode | |
| | phosphonate | Content | active material (wt %) | |
| | additive | (wt %) | B | C |
| Example 1 | A1 | 0.5 | 100 | |
| Example 2 | A1 | 0.05 | 100 | |
| Example 3 | A1 | 7 | 100 | |
| Example 4 | A1 | 15 | 100 | |
| Comparative | A2 | 0.5 | 100 | |
| Example 1 | | | | |
| Comparative | A3 | 0.5 | 100 | |
| Example 2 | | | | |
| Comparative | — | — | 100 | |
| Example 3 | | | | |
| Comparative | A1 + A4 | 1.0 | 100 | |
| Example 4 | (1:1 (A1:A4)) | | | |
| Comparative | A1 | 0.5 | | 100 |
| Example 5 | | | | |
| Comparative | A1 | 0.05 | | 100 |
| Example 6 | | | | |
| Comparative | A1 | 7 | | 100 |
| Example 7 | | | | |
| Comparative | — | — | | 100 |
| Example 8 | | | | |

The specific components described in Table 1 are as follows:
A1: Compound represented by Formula 1-1 above
A2: Lithium difluorophosphate (LiPO₂P₂)
A3: Compound represented by Formula 3 below

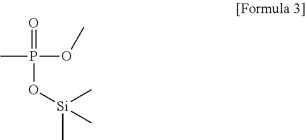

A4: 1,1,1,3,3,3-hexamethyldisiloxane
B: LiFePO₄
C: Li[Ni_{0.6}Co_{0.2}Mn_{0.2}]O₂

### Experimental Example

### (1) Evaluation of Internal Resistance (DCIR)

Charging and discharging were performed on the secondary batteries of the examples and comparative examples at each corresponding C-rate for 10 seconds, while sequentially varying the C-rate to 0.2C, 0.5C, 1.0C, 1.5C, 2.0C, 2.5C and 3.0C at a 60% state of charge (SOC) point at 25° C. Then, the terminal voltage points were plotted to construct a linear equation, and the slope of the resulting line was adopted as the DCIR.

### (2) Evaluation of Low-Temperature (−10° C.) Performance

### 2-1) Evaluation of Low-Temperature Internal Resistance (DCIR)

The lithium secondary batteries of the examples and comparative examples were left in a constant-temperature and humidity chamber at −10° C. for 4 hours, and then the low-temperature internal resistance (DCIR) was measured using the same method as in (1) above.

### 2-2) Evaluation of Low-Temperature Capacity Retention (Ret.)

The lithium secondary batteries of the examples and comparative examples were subjected to 0.2 C-rate CC/CV charging (3.65 V, 0.05C cut-off) at 25° C., followed by 0.5 C-rate CC discharging (2.5 V cut-off), and then the initial capacity was measured.

The lithium secondary batteries of the examples and comparative examples were subjected to 0.5 C-rate CC/CV charging (3.65 V, 0.05C cut-off) in a constant-temperature and humidity chamber at −10° C., followed by 0.5 C-rate CC discharging (2.5 V cut-off), and then the low-temperature discharge capacity was measured.

The low-temperature capacity retention was calculated as a percentage of the low-temperature discharge capacity relative to the initial capacity as follows.

$$Low - temperature capacity retention ( \% ) = ( Low - temperature discharge capacity / Initial capacity ) \times 100$$

### (3) Evaluation of High-Temperature (60° C.) Storage Properties

3-1) Evaluation of High-Temperature Internal Resistance (DCIR) after High-Temperature Storage

The lithium secondary batteries of the examples and comparative examples were subjected to 0.2 C-rate CC/CV charging (3.65 V, 0.05C cut-off) at 25° C., and then stored in a constant-temperature and humidity chamber at 60° C. for 12 weeks.

The internal resistance (DCIR) of the lithium secondary batteries of the examples and comparative examples stored at 60° C. for 12 weeks was measured using the same method as in (1) above.

3-2) Evaluation of High-Temperature Storage Capacity Retention (Ret.) after High-Temperature Storage

The lithium secondary batteries of the examples and comparative examples were subjected to 0.2 C-rate CC/CV charging (3.65 V, 0.05C cut-off) at 25° C., and then stored in a constant-temperature and humidity chamber at 60° C. for 12 weeks.

The lithium secondary batteries of the examples and comparative examples stored at 60° C. for 12 weeks were subjected to 0.5 C-rate CC discharging (2.5 V cut-off), and then the discharge capacity after high-temperature storage was measured.

The capacity retention was calculated as a percentage of the discharge capacity after high-temperature storage relative to the initial capacity measured in 2-2) above.

$$High - temperature storage capacity retention ( \% ) = ( Discharge capacity after high - temperature storage / Initial capacity ) \times 100$$

### (4) Evaluation of High-Temperature (45° C.) Cycle Life Properties

The lithium secondary batteries of the examples and comparative examples were subjected to 1 C-rate CC/CV charging (3.65 V, 0.05C cut-off) at 45° C., and the initial high-temperature charge capacity was measured.

Then, the batteries were subjected to 1 C-rate CC discharging (2.5 V cut-off). This charging and discharging cycle was repeated 600 times, and then the high-temperature discharge capacity was measured.

The high-temperature capacity retention was calculated as a percentage of the high-temperature discharge capacity relative to the initial high-temperature charge capacity.

$$High - temperature capacity retention ( \% ) = ( High - temperature discharge capacity / Initial high - temperature charge capacity ) \times 100$$

The evaluation results are shown in Table 2 below.

TABLE 2

| | | Evaluation of | | Evaluation of | | High- |
|---|---|---|---|---|---|---|
| | | low-temperature | | high-temperature | | temperature |
| | | (−10° C.) | | (60° C.) storage | | (45° C.) |
| | | performance | | properties | | cycle life |
| Classifi- | DCIR | DCIR | Ret. | DCIR | Ret. | properties |
| cation | (mΩ) | (mΩ) | (%) | (mΩ) | (%) | (%) |
| Example 1 | 48.7 | 172.1 | 41.7 | 69.3 | 83.9 | 92.0 |
| Example 2 | 49.1 | 174.2 | 41.0 | 70.2 | 84.0 | 90.4 |
| Example 3 | 48.9 | 173.3 | 41.2 | 69.8 | 83.9 | 91.3 |
| Example 4 | 50.3 | 178.1 | 40.5 | 71.9 | 82.6 | 88.7 |
| Comparative | 53.1 | 185.5 | 39.9 | 75.7 | 83.9 | 88.5 |
| Example 1 | | | | | | |
| Comparative | 51.9 | 190.0 | 39.6 | 89.9 | 84.9 | 89.1 |
| Example 2 | | | | | | |
| Comparative | 55.5 | 199.8 | 38.3 | 96.7 | 81.5 | 85.7 |
| Example 3 | | | | | | |
| Comparative | 51.5 | 184.9 | 40.2 | 74.3 | 83.1 | 87.6 |
| Example 4 | | | | | | |
| Comparative | 40.8 | 146.7 | 41.5 | 59.7 | 78.9 | 82.7 |
| Example 5 | | | | | | |
| Comparative | 40.4 | 145.4 | 42.1 | 59.0 | 79.7 | 83.8 |
| Example 6 | | | | | | |
| Comparative | 41.6 | 148.6 | 40.9 | 59.9 | 76.6 | 81.4 |
| Example 7 | | | | | | |
| Comparative | 39.3 | 148.5 | 42.7 | 59.9 | 80.7 | 84.6 |
| Example 8 | | | | | | |

Referring to Table 2, in the examples using the compound represented by Formula 1-1 as an additive, the internal resistance, low-temperature internal resistance, and internal resistance after high-temperature storage were 50.3 mΩ, 178.1 mΩ, and 71.9 mΩ or less, respectively. The low-temperature capacity retention, high-temperature storage capacity retention, and high-temperature cycle life properties were 40.5%, 82.6%, and 88.7% or more, respectively.

In Example 4, where the additive content exceeded 10 wt % based on the total electrolyte weight, the internal resistance was slightly increased, and the capacity retention and cycle life properties were slightly decreased.

In Comparative Examples 1 to 4, which included a phosphate compound other than the compound represented by Formula 1-1 as an additive or did not use the compound represented by Formula 1-1 as an additive, the internal resistance was increased, and the capacity retention and cycle life properties were decreased.

Comparative Examples 5 to 7, which used Li[Ni_{0.6}Co_{0.2}Mn_{0.2}]O₂ as a cathode active material (NCM-based cathode active material) and the compound represented by Formula 1-1 as an additive, showed relatively lower capacity retention and cycle life properties compared to Comparative Example 8, which used Li[Ni_{0.6}Co_{0.2}Mn_{0.2}]O₂ as a cathode active material and did not use an additive.

What is claimed is:

1. A lithium secondary battery comprising:
a cathode comprising a lithium metal phosphate;
an anode disposed opposite to the cathode; and
an electrolyte comprising a lithium salt, an organic solvent, and a phosphonate-based additive comprising a compound represented by Formula 1 below: 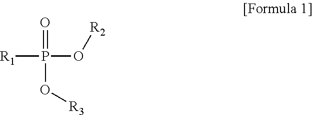
(in Formula 1, R₁ is an alkyl group having 1 to 8 carbon atoms, and R₂ and R₃ are each independently an alkylsilyl group having 1 to 6 carbon atoms).

2. The lithium secondary battery according to claim 1, wherein in Formula 1, R₁ is a methyl group or an ethyl group.

3. The lithium secondary battery according to claim 1, wherein in Formula 1, R₂ and R₃ are the same.

4. The lithium secondary battery according to claim 1, wherein in Formula 1, at least one of R₂ and R₃ is a trimethylsilyl group.

5. The lithium secondary battery according to claim 4, wherein in Formula 1, R₂ and R₃ are each independently a trimethylsilyl group.

6. The lithium secondary battery according to claim 1, wherein the phosphonate-based additive comprises a compound represented by Formula 1-1 below:

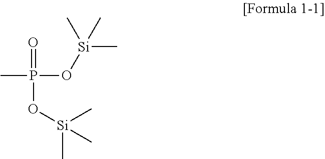

7. The lithium secondary battery according to claim 1, wherein the phosphonate-based additive is included in an amount of 0.01% by weight to 10% by weight based on the total weight of the electrolyte.

8. The lithium secondary battery according to claim 1, wherein the electrolyte further comprises at least one auxiliary additive selected from the group consisting of a cyclic carbonate compound, a fluorine-substituted cyclic carbonate compound, a sultone compound, a cyclic sulfate compound, a cyclic sulfite compound, a phosphate compound and a borate compound.

9. The lithium secondary battery according to claim 8, wherein the auxiliary additive is included in an amount of 0.01% by weight to 5% by weight based on the total weight of the electrolyte.

10. The lithium secondary battery according to claim 1, wherein the organic solvent comprises at least one selected from the group consisting of ethylene carbonate (EC), ethyl methyl carbonate (EMIC), dimethyl carbonate (DMC), and diethyl carbonate (DEC).

11. The lithium secondary battery according to claim 1, wherein the lithium metal phosphate comprises lithium iron phosphate (LiPePO₄, LFP).
